(19) United States
(12) Patent Application Publication
(10) Pub. No.: US 2011/0007535 A1
(43) Pub. Date: Jan. 13, 2011

(54) METHOD AND APPARATUS FOR CONVERTING AC POWER TO DC POWER

(76) Inventor: Zachary J. Gerbozy, Spring, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/919,393

(22) PCT Filed: Feb. 28, 2008
(86) PCT No.: PCT/US08/02685

§ 371 Date: Aug. 25, 2010

(51) Int. Cl. H02M 7/06

(52) U.S. Cl. 363/126

(57) ABSTRACT

A method and apparatus for converting AC power to DC power with increased efficiency. One embodiment of the method adjusts the switching frequency of the AC to DC converter base on the load. Another embodiment of the method optimizes the output boost voltage of the AC to DC converter.

### BACKGROUND

This invention relates to a method and apparatus for converting alternate current (AC) power to direct current (DC) power.

The voltage coming out of an electrical outlet may not be suitable for directly powering certain-devices such as computers, printers, telephones, and various other electronic and electrical devices. This is due to the fact that some electronic or electrical devices require DC power to operate while an electrical outlet supplies AC power. Thus, in order for the devices or loads that require DC power to receive power from an electrical outlet, a process called AC to DC conversion (or rectification) may be used to convert an AC voltage to supply power to a DC load. In some cases, this AC to DC conversion process may be performed by an AC to DC converter, and the AC to DC converter may be bundled together with other components in the power supply of a device.

During an AC to DC conversion process, certain amount of loss may be experienced, and the loss would detrimentally affect the efficiency of the AC to DC converter. Thus, it would be beneficial to increase the efficiency of an AC to DC converter. For example, increasing the efficiency of an AC to DC converter in a power supply would lower the power dissipation inside the power supply and reduce the size of the magnetic components of the power supply.

### BRIEF DESCRIPTION OF THE DRAWINGS

The method and apparatus for converting AC power to DC power are further described with reference to the accompanying drawings in which:

FIG. 1 is a diagram showing an exemplary power supply train circuit for use with an embodiment of the present invention.

FIG. 2 is graph showing the relationship between the efficiency of an exemplary power supply and an exemplary output load for different boost switching frequencies.

FIG. 3 is a graph showing the relationship between the efficiency of an exemplary power supply and an exemplary output load when switching frequency is changed at half load.

FIG. 4 is graph showing the relationship between the efficiency of an exemplary power supply and an exemplary output load for different output boost voltages.

FIG. 5 is a block diagram of an exemplary redundant computer/server power system.

### DETAILED DESCRIPTION OF EMBODIMENTS

The present invention provides a method and apparatus for converting AC power to DC power with increase efficiency. The embodiments of the present invention described herein may be used in power supplies for various electronic and electrical devices. Power supplies that utilize the present invention have increased efficiency, reduced power dissipation and/or reduced components size.

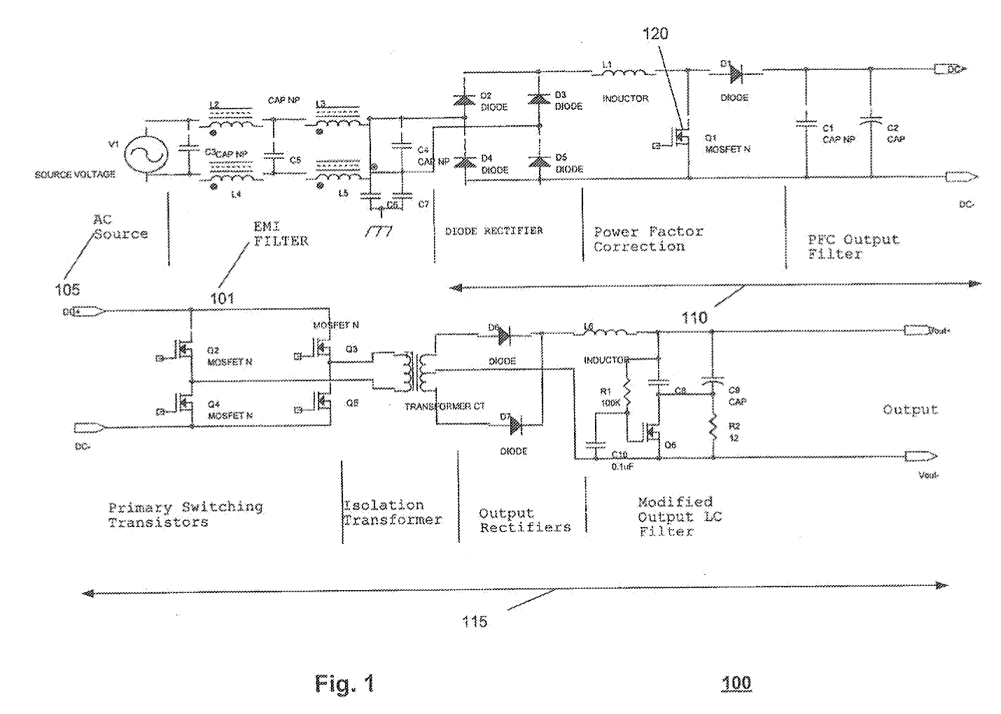

The method and apparatus for converting AC power to DC power may be used in various different kinds of power supplies. In one exemplary embodiment, the power supply comprises two power conversion stages. This aspect of the embodiment may be illustrated by the circuit diagram of FIG. 1.

FIG. 1 shows an exemplary power supply power train circuit 100. As shown in FIG. 1, the circuit comprises an AC voltage source 105 (V1), an EMI filter 101, a boost power conversion stage 110, and a DC to DC output stage 115. The EMI filter 101 in this example can comprises inductors L2 and L3 coupled in series to one of the outputs of voltage source 105, and inductors L4 and L5 coupled in series to the other output of voltage source 105. A capacitor C3 is coupled in parallel across the output terminals of voltage source 105, and a capacitor C5 is coupled in parallel to voltage source 105 with one of its terminals being coupled between inductors L2 and L3 and the other of its terminals begin coupled between inductors L4 and L5. Furthermore, a capacitor C4 is coupled in parallel to the voltage source 105, with one terminal being coupled to a terminal of inductor L3 opposite to that at which capacitor C5 is coupled, and the other terminal of capacitor C4 being coupled to a terminal of inductor L5 opposite to that at which capacitor C5 is coupled. In addition, capacitors C6 and C7 are coupled between the terminal of inductor L5 at which capacitor C4 is coupled and ground.

The boost conversion stage 110 may comprise a diode rectifier, a power factor correction, and a PFC output filter. The diode rectifier may comprise diodes D2, D3, D4, and D5. The diodes D2 and D4 may be coupled in series and the diodes D3 and D5 may be coupled in series and then in parallel with the serial connection of diodes D2 and D4. The terminals of capacitor C4 are connected between diodes D2 and D4 and diodes D3 and D5.

The power factor correction may include inductor L1, MOSFET Q1 and diode D1. The inductor L1 may be coupled in series with diode D1. The drain of MOSFET Q1 may be coupled between inductor L1 and diode D1 at the anode of diode D1, and the source of MOSFET Q1 may be coupled to the anodes of diodes D4 and D5 of the diode rectifier as shown. As described in more detail below, the switching frequency signal of the boost switch 120 is applied at the gate of MOSFET Q1.

The PFC output filter may include capacitors C1 and C2 coupled in parallel with each other. Accordingly, the output of the PFC output filter is taken across capacitor C2 in this arrangement. Further shown in the exemplary power supply in FIG. 1 are primary switching transistors, isolation transformer, output rectifiers and modified output LC filter.

The primary switching transistors may comprise MOSFET Q2 that may be coupled in series with MOSFET Q4, and MOSFET Q3 that may be coupled in series with MOSFET Q5. Specifically, the source of MOSFET Q2 can be coupled to the drain of MOSFET Q4, and the source of MOSFET Q3 can be coupled to the drain of MOSFET Q5. The series connection of MOSFET Q2 and Q4 may thus be coupled in parallel with the series connection of MOSFET Q3 and MOSFET Q5.

The isolation transformer may comprise transformer T1 and coupled to the primary switching transistors. One terminal of one side of the transformer T1 may be coupled to the connection between MOSFET Q3 and MOSFET Q5, and the other terminal of transformer T1 may be coupled to the connection between MOSFET Q2 and MOSFET Q4, respectively. The terminals at the other side of the transformer T1 (e.g., the output terminals of transformer T1) may be coupled to the output rectifiers.

The output rectifiers may comprise diodes D6 and D7 whose anodes may be coupled to two output terminals of the transformer T1. The cathode of diode D7 may be coupled to the cathode of diode D6 and then coupled to the modified output LC filter.

The modified output LC filter may comprise inductor L6, resistor RI and R2, capacitors C10, C8, and C9 and MOSFET Q6. In this exemplary arrangement, the cathode of diode D6 may be coupled to the inductor L6, and the other terminal of the inductor L6 may be coupled to on terminal of resistor R1 and one terminal of each of capacitors C8 and C9. The other terminal of resistor R1 may be coupled to one terminal of capacitor C10 and the gate of MOSFET Q6, and the other terminal of capacitor C10 may be coupled to the center tap of the isolation transformer T1. Capacitor C9 may be coupled to resistor R2 in series and in parallel with capacitor C8. Accordingly, the output would be taken across the series connection of capacitor C9 and resistor R2.

In this exemplary power supply train circuit, the boost conversion stage 110 maintains the output voltage (boost output) substantially constant while drawing a sinusoidal input current waveform. The boost output voltage may be higher than the peak AC input voltage.

Various mathematical formulae may be used to calculate the possible boost output voltage. For example, if the peak AC input voltage is 264 volts, the boost output voltage may be calculated by multiplying the peak AC input voltage by a factor of 1.414, which would yield a boost output voltage of 373.3. Typically, the boost output voltage may fall within the range of 385 volts to 400 volts.

In the boost power conversion stage of the exemplary power supply power train circuit 100, a boost switch 120 operates at a switching frequency. In this exemplary embodiment, the boost switch 120 is MOSFET Q1. Typically, the boost switch is designed to operate at a fixed switching frequency. For example, in some applications, the boost switch 120 is designed to operate at or around 225 kHz.

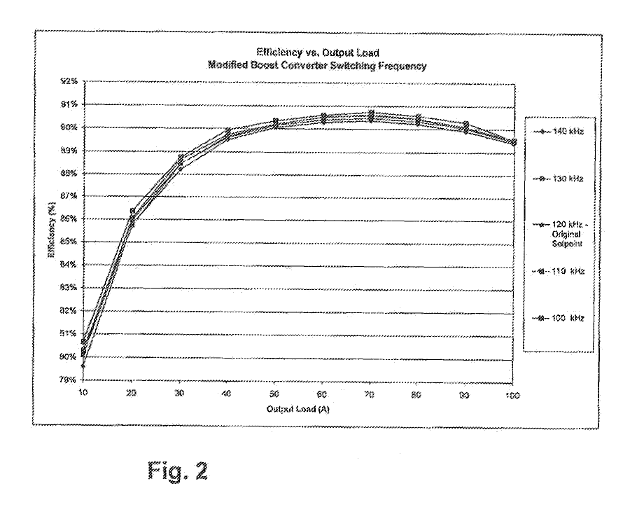

FIG. 2 shows the relationship between the efficiency of the exemplary power supply power train circuit 100 and various output load for different boost switching frequencies. As shown in FIG. 2, the efficiency of the exemplary power supply power train circuit is reduced when the load is reduced. Such reduction in efficiency may be caused by switching losses.

In an exemplary embodiment of the present invention, the switching frequency is modified and/or adjusted according to the output load. In other words, when the load is above a certain percentage, the switching frequency may be set at a higher frequency. As the load reduces, the switching frequency may be reduced. The reduction in switching frequency would reduce the switching losses, and hence increase the efficiency of the power supply. In one exemplary embodiment of the present invention, when the load is above 50%, the switching frequency may be set at 225 kHz. When the load falls below 50%, the switching frequency may be reduced to 120 kHz. In other exemplary embodiments of the present invention, the switching frequency may be changed at different percentages of the load. For example, the switching frequency may be changed at 35% to 65% of the full load. In further exemplary embodiments of the present invention, the switching frequency may be changed to different values multiple times as the load changes. The duty cycle may also be varied for line and load regulation, while the converter is drawing input current

Depending on the application of the AC to DC converter, the change in switching frequency may be instantaneous or delayed. In one exemplary embodiment of the present invention, the change in switching frequency may occur instantaneously when the load changes. In other exemplary embodiments of the present invention, the change in switching frequency may occur at a delay of several tens of milli seconds.

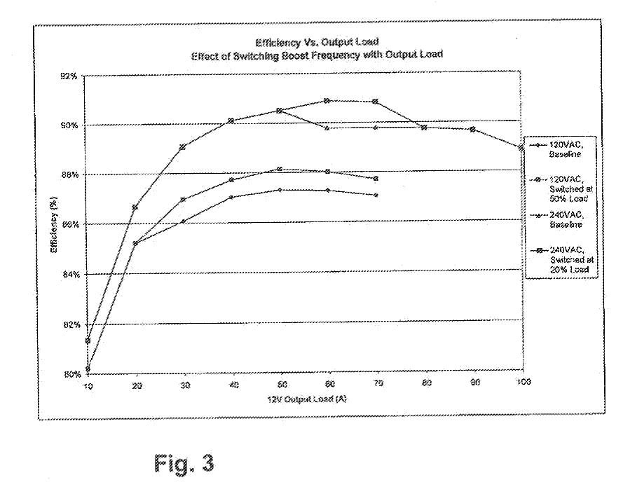

The relationship between the efficiency of an exemplary embodiment of the present AC to DC converter and various different output load is shown in FIG. 3. In FIG. 3, there are four curves showing the efficiency of the exemplary complete power supply with load. Two curves are for low line operation (120 volts AC input) of the exemplary power supply and the other two curves are for high line operation (240 volts AC input). In this example, the switching frequency is set at 225 kHz when the load is above 50%. When the load falls below 50%, the switching frequency is set at 120 kHz. As illustrated from FIG. 3, the efficiency of the exemplary power supply increases when the switching frequency is reduced as the load reduces.

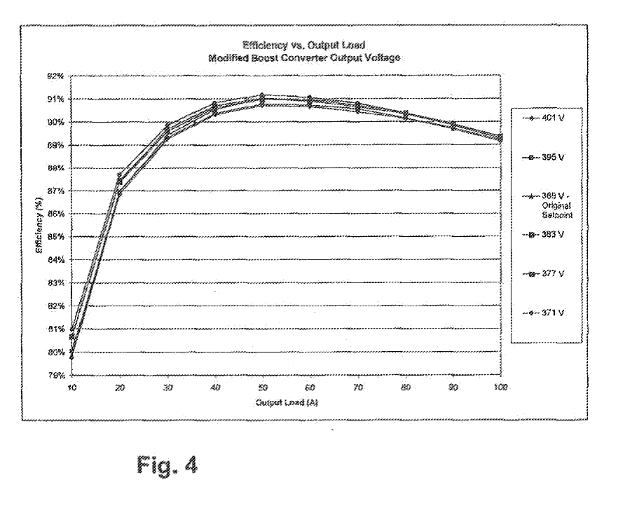

In another exemplary embodiment of the present invention, the efficiency of an AC to DC converter may be increased by optimizing the boost output voltage at the boost power conversion stage 110. For example, the boost output voltage may be held substantially constant at 376 volts for certain power supplies. FIG. 4 is an exemplary illustration of the relationship between the efficiency of an exemplary embodiment of the present invention from zero load to full load for various output boost voltage. In this example, the output voltage of the power supply is +12 volts and is maintained substantially constant by a DC to DC converter for load variation while providing safety isolation. As shown in FIG. 4, by optimizing the boost output voltage at 376 volts, the efficiency may be increased.

Different embodiments of the present invention may be combined to achieve increased efficiency for an AC to DC converter. For example, by changing the switching frequency based on load variation and optimizing the boost output voltage, increased efficiency may be achieved.

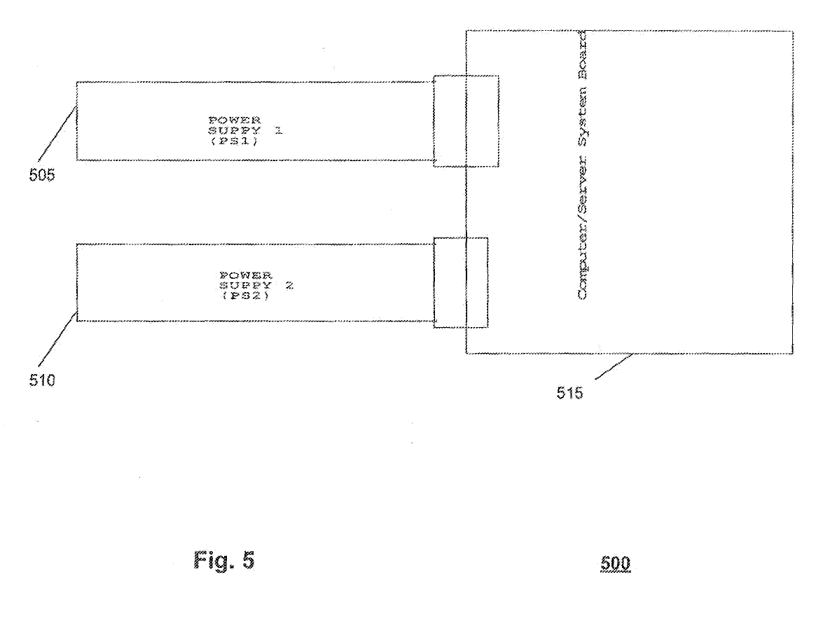

Furthermore, different embodiments of the present invention may be combined and used in redundant operations such as the N+N redundancy system shown in FIG. 5. In FIG. 5, the system 500 is in redundant mode operation in which multiple power supplies 505 and 510 are operating in parallel to supply power to one or more devices 515. Thus, the full load is being shared by multiple power supplies. Consequently, each power supply would be operating on much lighter load for longer periods of time. In this exemplary illustration, different embodiments of the present invention may be used individually or in combination to enhance the efficiency of the power supplies.

It is understood that the herein described apparatus and methods are susceptible to various modifications and alternative constructions. There is no intention to limit the invention to the specific constructions described herein. To the contrary, the invention is intended to cover all modifications, alternative constructions, and equivalents falling within the scope and spirit of the invention.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention.

What is claimed is:

1. A method of increasing efficiency of an AC to DC converter, comprising the step of
adjusting the switching frequency of the AC to DC converter according to the load of the AC to DC converter.

2. The method as recited in claim 1, wherein the adjusting step further comprises:
reducing the switching frequency when the load falls below a threshold.

3. The method as recited in claim 1, wherein the adjusting step further comprises:
increasing the switching frequency when the load rises above a threshold.

4. A method of increasing efficiency of an AC to DC converter, comprising the step of:
optimizing the boost output voltage of the AC to DC converter.

5. The method as recited in claim 1, further comprising:
adjusting the switching frequency when the load is 35% to 60% of the full load.

6. The method as recited in claim 1, further comprising:
adjusting the switching frequency to 120 kHz when the load falls below 50% of the full load.

7. The method as recited in claim 1, further comprising:
adjusting the switching frequency to 225 kHz when the load rises to or above 50% of the full load.

8. The method as recited in claim 4, further comprising:
optimizing the boost output voltage to 376 volts.

9. An AC to DC converter, comprising:
a boost power conversion stage, and
a boost switch for adjusting the switching frequency of the boost power conversion stage according to the load of the AC to DC converter.

10. The AC to DC converter as recited in claim 9, wherein:
the boost switch reduces the switching frequency when the load falls below a threshold.

11. The AC to DC converter as recited in claim 9, wherein:
the boost switch reduces the switching frequency when the load rises above a threshold.

12. The AC to DC converter as recited in claim 9, wherein:
the boost switch adjusts the switching frequency when the load is 35% to 60% of the full load.

13. The AC to DC converter as recited in claim 9, wherein:
the boost switch adjusts the switching frequency to 120 kHz when the load falls below 50% of the full load.

14. The AC to DC converter as recited in claim 9, wherein:
the boost switch adjusts the switching frequency to 225 kHz when the load rises to or above 50% of the full load.

15. An AC to DC converter, comprising:
a boost power conversion stage; wherein
the boost output voltage of the boost power conversion stage is optimized.

16. The AC to DC converter as recited in claim 15, wherein:
the boost output voltage of the boost power conversion stage is optimized to 376 volts.
